(19) United States
(12) Patent Application Publication
(10) Pub. No.: US 2006/0231533 A1
(43) Pub. Date: Oct. 19, 2006

(54) Laser beam welding method

(76) Inventor: Wolfgang Danzer, Dorfen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/544,383

(22) PCT Filed: Jan. 29, 2004
(86) PCT No.: PCT/EP04/00805

§ 371 Date: Dec. 9, 2005

(30) Foreign Application Priority Data
Feb. 4, 2003 (DE) 103 04 474.4

(51) Int. Cl. B23K 26/00

(52) U.S. Cl. 219/121.63

(57) ABSTRACT

A method for laser beam welding with a fiber laser is provided. A process gas containing an active gas is directed to the machining point. Carbon dioxide, oxygen, hydrogen, nitrogen, or a mixture of said gases are particularly suitable as active gases. The process gas advantageously also contains helium and/or argon.

This application claims the priority of German patent document 103 04 474.4, filed Feb. 4, 2003 (PCT International Application No. PCT/EP2004/000805, filed Jan. 29, 2004), the disclosure of which is expressly incorporated by reference herein.

### BACKGROUND AND SUMMARY OF THE INVENTION

The invention relates to a method for laser beam welding using a fiber laser, whereby a laser beam created by the fiber laser is focused on a location to be machined or in the vicinity of a location to be machined.

The properties of laser radiation, in particular the intensity and good focusability, have resulted in lasers being used today in many fields of machining materials. Laser machining systems are known per se. They usually have a laser machining head, optionally with a nozzle arranged coaxially with the laser beam. Laser machining systems are frequently used in combination with a CNC control unit. Lasers have always been used extensively in welding, because laser welding offers a more targeted heat input, lower deformation and a higher welding speed in comparison with conventional welding methods (MAG, TIG). Most laser welding does not require the use of filler material. However, this may be necessary in order to bridge a gap or for the metallurgy. Laser welding can be used with almost all materials such as steels, light metals and thermoplastics.

A focused laser beam is understood within the scope of this invention to refer to a laser beam focused essentially on the workpiece surface. In addition to the most widely used method with the laser beam focused on the workpiece surface, this invention may also be used with the less common variant in which the laser beam is not focused exactly on the workpiece surface.

The latest developments in laser technology have opened the possibility of using fiber lasers in laser welding. The fiber lasers are a completely new generation of lasers. Fiber lasers differ fundamentally in their properties from the CO₂ lasers, the Nd:YAG lasers and the diode lasers used in the past. The highest laser powers are achieved with CO₂ lasers. The laser power of the fiber laser is comparable to the laser power of the CO₂ laser and the Nd:YAG laser (the diode laser is characterized by a much lower laser power and therefore behaves significantly differently in laser welding than the high-power lasers) and currently amounts to a few hundred watts. The wavelength of the fiber laser is in the range of 1060 nm to 1080 nm because rare earths such as ytterbium are used as the active medium, which is thus comparable to the wavelength of the Nd:YAG laser. However, the significant difference lies in the divergence of the laser beam, the focus diameter, the focus length or the beam parameter product. Of these parameters, the beam parameter product is the parameter which is defined by the laser and determines the properties of the laser to a significant extent. The beam parameter product is a constant quantity which depends on the laser design. It cannot be altered by optical components (lenses or mirrors). The beam parameter product is defined as the product of the beam radius in the waist and half the divergence angle (far-field beam angle) as beam parameters and is given in units of mm″ mrad. Consequently, the beam parameter product is a measure of the focusability of a laser beam. The smaller the beam parameter product of a laser, the smaller is the area on which a laser beam can be focused. Beam parameter products for high-power lasers are typically between 3 and 30 mm″ mrad. With the newly developed fiber lasers, beam parameter products of less than 1.6 mm″ mrad have now been achieved, even less than 1.4 mm″ mrad. With a beam diameter of 80 μm, a beam parameter product of less than 1.6 mm″ mrad would mean a divergence of less than 40 mrad. If the power of the fiber laser is 700 watts, for example, then a power density of more than 50 MW/cm² is achieved at a machining point. The focus at the machining point is approximately 40 μm in this example. The focus length of the fiber laser is approximately 150 mm. This means that the high-power density is retained over a path length of 150 mm and consequently can be found not only on the surface of the workpiece but also in the workpiece or beyond the workpiece (in the case of workpieces with a thickness less than or equal to 1.5 cm). The reason for the high-power density at the machining site is thus to be found in the excellent focusability of the fiber laser, which is specified by means of the beam parameter product. In comparison with that, the power density at the machining site for the high-power lasers conventional in the past is in the range of a few MW/cm and the focus is in the range of mm. The power density at the machining site has been multiplied as a result of the introduction of the fiber laser. For example, the company IPG Photonics offers fiber lasers with laser powers of 300 W to 700 W and beam parameter products of less than 0.7-1.4 mm″ mrad; these fiber lasers have a focus diameter of less than 30 μm to 50 μm at the machining site and have a focus length of 150 mm. The fiber lasers may be operated either in pulsed or continuous operation.

In laser beam welding with high-power lasers, material is vaporized and/or ionized at the machining site and moved away from the workpiece in the direction of the laser. At the machining site a vapor capillary is created in the material. Through this vapor capillary, the laser energy goes deep into the material. Therefore, thinner welds can be produced much more rapidly than would be possible through thermal conduction of the solid material from the surface into the depth of the material. In creating this vapor capillary, also known as a keyhole, very hot vaporized material that is actually ionized at higher laser powers, flows toward the laser beam. The plasma material interacts with the laser beam and influences it thereby. If the optical density of the metal vapor or metal plasma is too high, the laser radiation may no longer reach the workpiece and the welding process becomes ineffective or even collapses. Absorption of the laser radiation occurs mainly due to thermally ionized plasma. Formation of a plasma is especially problematical at high laser powers and leads to the failure of the welding operation. Therefore, at high laser power levels, a process gas is generally used. If the required energy density is not available, then only the metal vapor absorbs. The resulting loss of laser power may reduce the welding speed by many times 10% but does not usually result in termination of the welding process. Since the laser power of Nd:YAG lasers is generally lower than the laser power of a CO₂ laser, it is often possible to omit the process gas in welding with Nd:YAG lasers.

With the fiber laser, a different behavior is now manifested with respect to the vapor capillary. Because of the high-power density at the machining site and the very small focus diameter, the result is a very fine vapor capillary of vaporized material and plasma. Since the focus length is very long, the diameter of the vapor capillary is proportional to the focus diameter and the diameter of a vapor capillary produced by a fiber laser is many times smaller than the diameter of a vapor capillary produced with a traditional high-power laser. Consequently, a very narrow capillary is formed. It is very difficult for vapor and plasma to escape from this very fine and long capillary. Consequently, a very dense plasma is formed in the capillary, through which the laser beam can penetrate only with great difficulty. Because of the narrowness of the very long capillary, the behavior of the plasma and the vapor differs significantly from the behavior of a plasma formed by using the high-power lasers customary in the past. However, when using a fiber laser so that high-quality laser welds are produced, the plasma and the vapor must be controllable.

A number of problems occur in laser welding with fiber lasers and it is extremely difficult to produce a high-quality weld. The problems differ greatly from the problems encountered in using the high-power lasers customary in the past. These problems can be attributed to the high-power density at the machining site in combination with the great focus length of the fiber laser.

Therefore, the present invention is based on the object of providing a method which permits high-quality laser welding using a fiber laser.

This object is achieved according to this invention by directing a process gas containing an active gas at the machining site. Since the process gas surrounds the weld, the latter is protected from the environment. An important disadvantage of ambient air—in addition to the aggressive components—is the humidity present in the air because it promotes the formation of pores that reduce quality. It is therefore important for the process gas to be free of impurities accordingly. Therefore, process gas for laser welding usually contains inert gases. By adding active gases to the process gas, the properties of the weld and the material of the workpiece in the immediate vicinity of the weld are influenced. Due to the active gases, the structure of the material in the environment of the weld can be influenced in a targeted manner and chemical and physical reactions take place at the surface. In the narrow capillary, pores and other irregularities may easily develop if the process gas and/or the ambient air is inadequately distributed in the narrow capillary. By adding active gases, a uniform distribution of the process gas is supported and consequently the development of pores is suppressed. In addition, with active gases there is a transport of energy into the vapor capillary. In the process, the gases undergo dissociation (if they are molecular gases) and ionization under the influence of the laser beam on entrance into the vapor capillary. When the gases recombine, which takes place when there is a decline in energy density, the ionization and dissociation energy is released again. The process gas flows into the vapor capillary and the laser energy declines at the base of the capillary, so recombination takes place at the base of the vapor capillary. The recombination energy is thus released at the point where material must be vaporized. The energy transport is now of crucial importance especially with the very narrow capillaries. This ensures that material is vaporized at the base of the capillary instead of material being melted by thermal conduction. If there is a change in the mechanism of formation of the weld during the welding process, the behavior of the vaporized material and the process gas changes so that pores are formed in the weld. A welding process that is continuous microscopically is absolutely essential for high-quality welding processes and that is what is achieved with the inventive process. In addition, high welding speeds are achieved because the relatively slow thermal conduction is irrelevant for the welding process.

The active gas advantageously contains carbon dioxide, oxygen, hydrogen, nitrogen or a mixture of these gases. These gases are characterized in that the basic substance can be influenced in a particularly advantageous manner through chemical and physical reactions with it. Furthermore, these molecular gases ensure effective energy transport into the vapor capillary. Thus the development of pores is suppressed with these gases and the welding speed is also significantly increased.

### DETAILED DESCRIPTION

In an advantageous embodiment of this invention, the process gas contains 0.01 vol % to 50 vol %, preferably 1 vol % to 30 vol %, especially preferably 5 vol % to 20 vol % active gas. With certain materials such as aluminum and aluminum alloys, improvements in the appearance of the welds are obtained even with very small quantities in the vpm range, but negative effects that may play a role with sensitive materials do not play any role here. With larger amounts by volume, energy transport also plays a role. The upper limit is mostly obtained on the basis of the negative effects of the active gases on the quality of the weld. However, it may also be a crucial factor that the helium content cannot be further reduced without reducing the quality or having a negative effect on the welding process.

Helium and/or argon is advantageously present in the process gas. Since helium and argon are inert gases, the machining site is protected from the environment by them. Helium has the ability to control and limit the development of the plasma and is a very small and light gas which vaporizes very easily. The property of controlling the plasma is based on the difficulty in ionizing helium and the increased transparency of the plasma and vapor for the laser beam and the energy of the laser beam thus reaches the base of the capillary where material is vaporized. Owing to the easy volatility of helium, a process gas containing helium actually goes very deep into the very narrow vapor capillary. This is of crucial importance because the vapor capillary created by the fiber laser has a very small diameter which is attributed to the small focus diameter of the fiber laser and it also retains this small diameter over almost the entire depth, which is attributed to the low divergence of the fiber laser beam. Helium with its easy volatility then penetrates into this capillary with no problem and propagates uniformly in it without tending to collect at certain locations or where there is direct contact with material. Therefore, the helium in the process gas ensures a uniform distribution of the active gases in the very fine capillary. This is extremely important, so that the reactions of the active gases with the surface and the material take place uniformly at all locations and there are no quality-reducing irregularities or development of pores in the weld that would diminish quality. In addition, the uniform distribution of active gases is also essential for an effective energy transport based on recombination. Argon does not assist in controlling the plasma in the vapor capillary but instead behaves like an inert element and thus suppresses any harmful effects from the environment. However, since this gas is definitely less expensive, it is often advantageous to replace some of the helium with argon. It is often possible here to obtain the advantages attributed to the helium content. However, since the inventive advantages are obtained because of the active gases, it is also possible to add the active gases to pure argon although then the advantages of plasma control are lost. Instead of argon, other inert gases such as noble gases or mixtures of inert gases may also be used as a component of the process gas. Binary mixtures of active gases and helium and active gas and argon are advantageous. Ternary mixtures of active gas, helium and argon can also be used to advantage. In many cases, it is advantageous to use a mixture of different active gases instead of using one active gas.

In an advantageous embodiment of this invention, a process gas containing 10 vol % to 90 vol % helium, preferably 20 vol % to 70 vol % helium, especially preferably 30 vol % to 50 vol % helium is used. In these volume ranges, the advantages of plasma control attributed to helium are obtained. The amount of helium to be selected depends on the quality to be achieved, the welding speed, the material and economic considerations.

The inventive method has its advantages with almost all materials. It is suitable for welding steels (unalloyed, low alloy and high alloy), stainless steel, corrosion-resistant steel, aluminum, aluminum alloys, copper-based materials and nickel-based materials.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-5. (canceled)

6. A method of laser beam welding using a fiber laser, comprising the steps of:
focusing a laser beam produced by the fiber laser at least one of on or near a machining site; and
directing a process gas containing an active gas at the machining site.

7. The method of claim 6, wherein the active gas is at least one of carbon dioxide, oxygen, hydrogen and nitrogen.

8. The method of claim 6, wherein the active gas is 0.01 vol % to 50 vol % of the process gas.

9. The method of claim 6, wherein the active gas is 1 vol % to 30 vol % of the process gas.

10. The method of claim 6, wherein the active gas is 5 vol % to 20 vol % of the process gas.

11. The method of claim 7, wherein the active gas is 0.01 vol % to 50 vol % of the process gas.

12. The method of claim 7, wherein the active gas is 1 vol % to 30 vol % of the process gas.

13. The method of claim 7, wherein the active gas is 5 vol % to 20 vol % of the process gas.

14. The method of claim 6, wherein the process gas comprises at least one of helium and argon.

15. The method of claim 7, wherein the process gas comprises at least one of helium and argon.

16. The method of claim 8, wherein the process gas comprises at least one of helium and argon.

17. The method of claim 11, wherein the process gas comprises at least one of helium and argon.

18. The method of claim 14, wherein the process gas comprises 10 vol % to 90 vol % helium.

19. The method of claim 14, wherein the process gas comprises 20 vol % to 70 vol % helium.

20. The method of claim 14, wherein the process gas comprises 30 vol % to 50 vol % helium.

21. The method of claim 15, wherein the process gas comprises 10 vol % to 90 vol % helium.

22. The method of claim 15, wherein the process gas comprises 20 vol % to 70 vol % helium.

23. The method of claim 15, wherein the process gas comprises 30 vol % to 50 vol % helium.

24. The method of claim 16, wherein the process gas comprises 10 vol % to 90 vol % helium.

25. The method of claim 16, wherein the process gas comprises 20 vol % to 70 vol % helium.

26. The method of claim 16, wherein the process gas comprises 30 vol % to 50 vol % helium.

27. The method of claim 17, wherein the process gas comprises 10 vol % to 90 vol % helium.

28. The method of claim 17, wherein the process gas comprises 20 vol % to 70 vol % helium.

29. The method of claim 17, wherein the process gas comprises 30 vol % to 50 vol % helium.
